(19) United States
(12) Patent Application Publication
(10) Pub. No.: US 2012/0069321 A1
(43) Pub. Date: Mar. 22, 2012

(54) IMAGING DEVICE AND CIRCUIT FOR SAME

(76) Inventors: Gerard T. Quilligan, Gulf Breeze, FL (US); Jeffrey J. DuMonthier, Ashburn, VA (US); George Suarez, Burtonsville, MD (US)

(21) Appl. No.: 12/887,988

(22) Filed: Sep. 22, 2010

(51) Int. Cl. G01C 3/08

(52) U.S. Cl. 356/5.01

(57) ABSTRACT

An apparatus and method for imaging a target area is provided. Light is directed to a target area where it reflects off objects. The light is then returned to a receiving device. This receiving device creates a signal indicative of the intensity of the received light. The time of flight for the light plus the shape of the signal are analyzed to determine the range and shape of objects in the target area.

### FIELD OF THE INVENTION

The present invention is directed to a light detection and ranging (LIDAR) system. The invention is also directed to a circuit for a LIDAR system.

### BACKGROUND

LIDAR systems have been used in a variety of operations to achieve range data. In its most basic form, LIDAR utilizes a light emitter, typically a laser emitter, and a light receiver, such as a photodetector. The light emitter directs light to a target area. Upon striking objects in the target area, a portion of the light is reflected back to a receiving device which registers the reflected light. By measuring the difference in time between when the light is emitted and when it is received, the distance from the system to objects in the target area may be determined. This information may be used to create an image.

Typical LIDAR light sources emit either a scanning beam of light or a single flash of light. Scanning systems typically comprise a series of mirrors to control the position of a laser beam and scan it along a target area. The laser is pulsed at a high rate, and the time of return is recorded for each pulse. Flash systems emit a single flash of light, which covers an entire target area, eliminating the need for scanning mirrors and a pulsed laser. Flash systems typically utilize a photo-detector array so that different parts of the array correspond to different locations in the target area. Because these systems only create range data, they are often connected to global positioning systems to provide location information of the target area.

LIDAR systems can provide numerous advantages in a variety of fields, for instance, surveying and topographical mapping. Aircraft or satellites may be fitted with LIDAR systems to acquire information such as determine terrain elevation or the changes in shore lines.

### SUMMARY

In an exemplary embodiment, the invention is directed to a circuit for analyzing a signal produced by a light imaging device. The circuit comprises a plurality of comparators for receiving an input signal from the light detection and ranging device and providing an output. The comparators are each associated with a respective unique reference voltage. A plurality of register sets are electrically connected to and associated with a corresponding comparator. Each register set has at least two respective registers. A timing device for generating a timing signal is electrically connected to each register. The registers are able to store data representing the timing signal for each output signal generated by an associated comparator.

In another exemplary embodiment, the invention is directed to a method of imaging a target. A flash of light is emitted to a target area. When the flash of light is initiated, a timing device is activated. Light is reflected off the target area and received. This received light is converted into a signal. This signal is then analyzed to determine when it crosses a plurality of thresholds.

### BRIEF DESCRIPTION OF THE DRAWINGS

FIG. 1 is a schematic view of an exemplary system for imaging a target.

FIG. 2 is a flow chart of an exemplary method for imaging a target.

FIG. 3 is a schematic view of an exemplary circuit used for imaging a target.

FIG. 4 is a group of charts showing an exemplary signal.

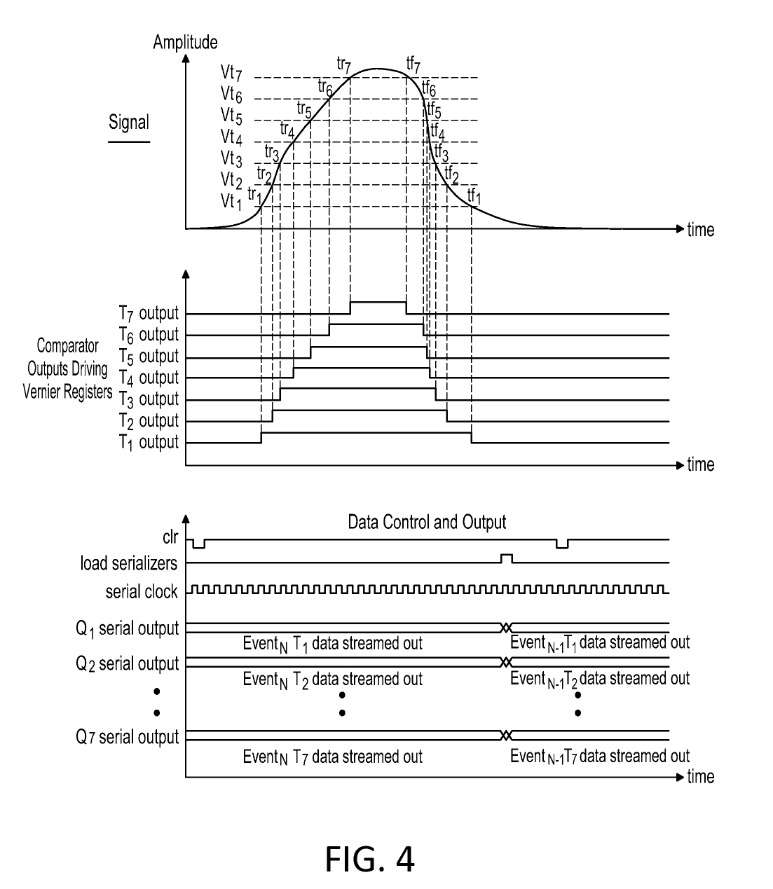

### DETAILED DESCRIPTION OF EXEMPLARY EMBODIMENT(S) AND EXEMPLARY METHOD(S)

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

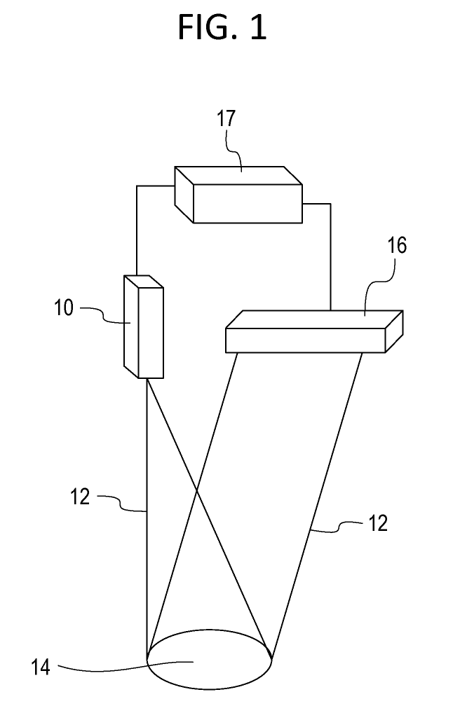

Various exemplary embodiments are directed to devices and methods for imaging. As best shown in FIG. 1, a light emitter 10 emits a beam of light 12 directed to a target area 14. The beam of light 12 reflects off objects in the target area 14 and is directed back towards a receiving device 16. Both the light emitter 10 and the receiving device 16 are connected to an analyzing device 17. The overall system may be operated by an external controller (not shown). The system may be attached to a variety of stationary platforms or mobile platforms including satellites, airplanes, helicopters, or motor vehicles. Additionally, the system may be associated with stationary or mobile robotic systems to permit movement and manipulation of the system.

The light emitter 10 may be, for example, a laser, laser diode, LED, or other light source. In an exemplary embodiment, the light emitter 10 is designed to emit a single flash of light which can be used to image a target area 14. The type and strength of light may vary depending on the application and objects to be imaged. The light emitter 10 may also comprise optical elements, such as lenses, mirrors, and/or telescopes. These optical elements may direct the beam of light 12 as well as shape the beam of light 12, such as by increasing it to a desired size.

The receiving device 16 may comprise a number of different components. For example, the receiving device 16 may have optical elements for receiving and directing light reflected from the target area 14. The light is directed to a photoelectric device (not shown) which receives the light and converts it into an electric signal. In an exemplary embodiment, the light is directed to a focal plane array (not shown). The size of the array may vary, and may be uniform, such as a 4×4 array, or non-uniform such as a 6×4 array. Elements in the array receive a portion of the light 12 returned from the target area 14 and convert the received light into an electrical signal.

The electrical signal is sent to the analyzing device 17. The analyzing device 17 may include a number of components and circuits. For example, a timing circuit may be used to measure the time of flight of the light 12 from light emitter 10 to the receiving device 16. The timing circuit is activated upon an initiating signal. This signal may be received from the light emitter 10 or from a sensor (not shown) connected to the timing circuit which determines that a beam of light 12 has been emitted. The timing circuit is deactivated once all the light 12 has been received from the target area 14, as discussed in greater detail below.

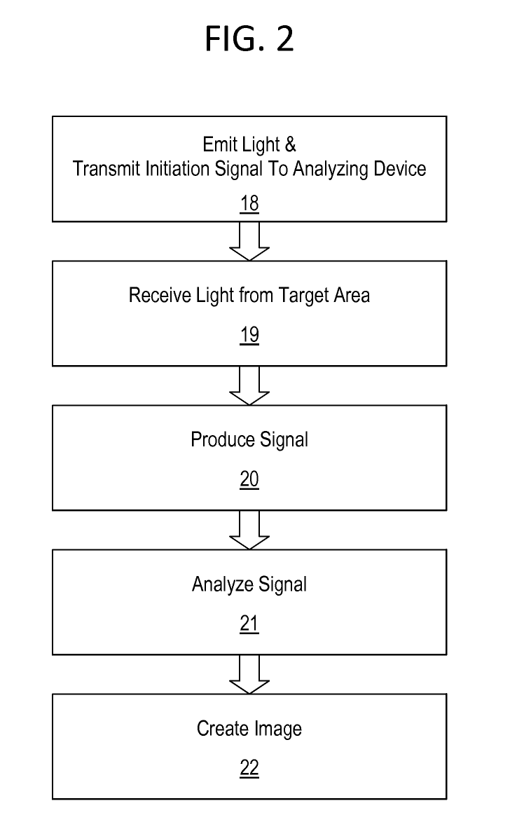

A more detailed overview of the operation of the receiving device 16 and analyzing device 17, according to this exemplary embodiment, is shown in FIG. 2. In step 18, the analyzing device 17 receives an initiating signal indicating light 12 has been emitted. In step 19, the receiving device 16 receives light 12 reflected from the target area 14. In step 20, the receiving device 16 produces a signal 24 corresponding to the received light. The signal 24 may be produced from a photoelectric device. The signal 24 may represent not only that light was received, but also the intensity of the light as it is being received. For example, a photodetector, such as an array of photodiodes, will receive light 12 and output either current or voltage. The intensity of the light received may vary over a period of time, thus the output of the photodetector will vary accordingly. Next, the receiving device 16 sends the signal 24 to the analyzing device 17 to be analyzed in step 21. Analyzing step 21 will determine the time elapsed from when the light 12 was emitted to when it was received by the receiving device 16. Additionally, the analyzing step 22 may determine the shape of the signal 24 at a given time. An exemplary device for analyzing the shape of the signal 24 at a given time is discussed in greater detail below. This information can then be used to provide data representative of the target area in step 22. By analyzing the shape of the produced signal 24, the data produced in step 22 represents the intensity of the light reflected from different objects in the target area 14, as well as the distance from the light emitter 10 to the target area 14. This allows individual objects in the target area 14 to be imaged, as opposed to a traditional LIDAR system which only provides range data but not shape imaging.

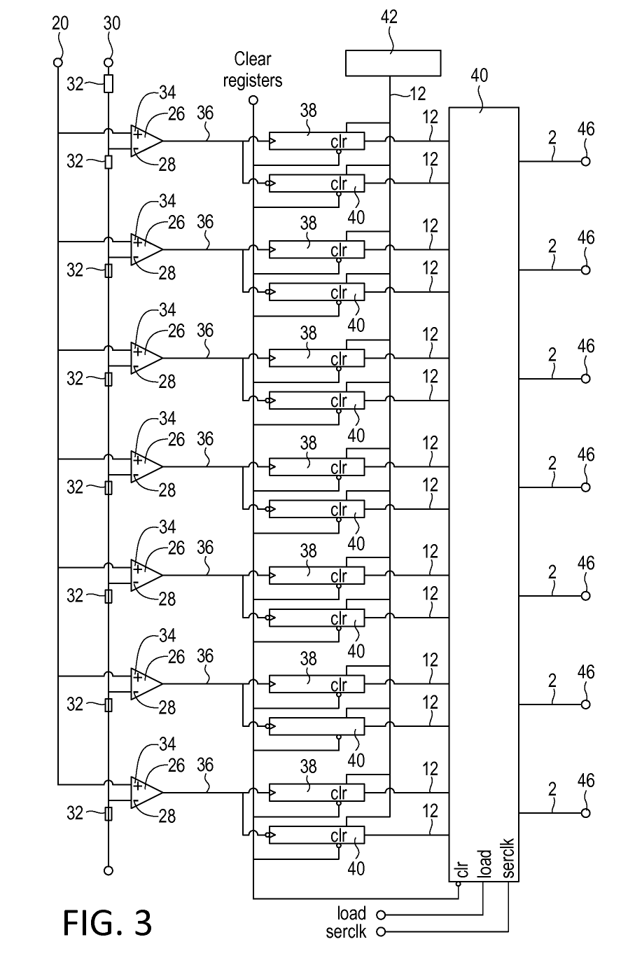

FIG. 3 is a schematic of an exemplary circuit utilized in the analyzing step 21 to determine the time of flight for the light 12 and shape of the signal 24. The circuit shown in FIG. 3 comprises a plurality of comparators 26. Though seven comparators 26 are shown in FIG. 3, it should be understood that the number of comparators 26 used may vary. In an exemplary embodiment, 2^{N}−1 comparators 26 are used, where N is the desired resolution of the system, so that for a 3-bit system seven comparators 26 are used.

While a 3-bit system is shown in FIG. 3, higher resolution systems, such as 8-bit (255 comparators) systems and above are contemplated and can provide more detailed information. The comparators 26 may be, for example, non-latched high speed comparators. The negative input 28 of each comparator 26 is connected to a reference voltage 30. Resistors 32 are placed between the reference voltage 30 and the negative input 28 of each comparator 26 to provide a threshold voltage value for each comparator that is unique. The value of these resistors 32 can be varied to provide different threshold values as needed. In an exemplary embodiment, the threshold voltage 30 for each comparator 26 will differ by 1 least significant bit.

Each comparator 26 has a positive inputs 34 that is connected to the input from the signal 24. The comparators 26 compare the input signal 20 to their associated unique threshold voltage 28 to produce outputs 36. When the input signal 24 is below the threshold value associated with an individual comparator 26, the output 36 for the comparator 26 is assigned a logic 0. When the input signal 24 exceeds the threshold value associated with an individual comparator 26, the output 36 for the comparator 26 is assigned a logic 1. Crossing the threshold of a comparator 26 is an active event. Thus, for each input signal 24, a comparator 26 will have two active events: one when the threshold is initially crossed (the rising edge of the signal 24) so that the output 36 switches from 0 to 1; and one where the threshold is crossed again (the falling edge of the signal 24) so that the output 36 switches from 1 to 0.

In an exemplary embodiment, each comparator 26 is connected to a set of registers including a respective first register 38 and a respective second register 40. The registers 38, 40 may be vernier-type registers. The first register 38 will store data when the signal input 24 crosses the threshold of the associated comparator 26 for the first time. Thus, when the output 36 switches from 0 to 1, the first register 38 will store data which is indicative of the rising edge of the signal 24. The second register 40 will store data when the signal input 24 crosses the threshold of the associated comparator 26 for the second time. Thus, when the output 36 switches from 1 to 0, the second register 40 will store data which is indicative of the falling edge of the signal 24. The storage of data may be performed, for example, by a latch. Timing device 42 supplies a timing signal input for the registers 38, 40. Timing device 42 may be a serial clock, timing vernier, or other known timing device. For example, the timing device 42 may be a timing vernier which uses a precision ring oscillator. The oscillator supplies timing data which is a function of the oscillator's stage delay and time.

In operation, the registers 38, 40 receive a clear command, such as when receiving the initiating signal 18 indicating that light 12 has been emitted to the target area 14. The timing device 42 then begins counting. As the signal 20 crosses each threshold, a comparator 26 outputs a signal to its associated register 38, 40. When the threshold of the first comparator 26 is crossed by the falling edge of the signal 20 the event is considered finished. In an exemplary embodiment, the registers 38, 40 output data to a serializer 44 after the event is finished. The output data is indicative of the time the threshold for each comparator 26 was crossed by the rising edge and falling edge of the signal 24. The serializer takes the outputs from the registers 38, 40 and serializes the data into single bit streams which can then be output for further processing. Thus the number of final outputs 46 can be limited to the number of comparators 26. In an alternative embodiment, each output from the registers 38, 40 can have dedicated input/output pins; though the number of outputs may become excessive depending on the number of comparators 26 used in the circuit.

The serializer output 46 can be directed to a storage medium, such as computer memory including ROM, RAM, or other form of memory (not shown). The output 46 may also be transmitted to a processor (not shown). A processor may be programmed to receive the data and compile an image of the target area 14. The data from the serializer outputs 46 may be stored or processed in a variety of other ways that will be known by one of ordinary skill in the art upon viewing the disclosure set forth herein.

In an alternative exemplary embodiment, before reaching the comparators 26, the signal 24 may be modified. In an ideal light imaging system, the laser pulse widths would be extremely narrow, facilitating minimal signal processing. This makes it easier to determine exactly when the light 12 is detected. The ideal signal detection point is at the center of an idealized Gaussian wave-shape, hence the benefit of a narrow pulse. A narrow pulse, however, requires wideband detection circuitry which can result in increased thermal noise. Instead of using a narrow pulse, signal processing can be implemented which shapes the received signal 20 into a pseudo-Gaussian form. This may be achieved by a charge amplifier and a shaping filter. In these cases, only range information can be extracted, as the narrow pulse would yield little intensity information and any subsequent filtering would attenuate it further.

FIG. 5 shows an exemplary signal 20. Vt₁-Vt₇ represent the threshold for each comparator 26. The output 36 of the comparators 26 is triggered at points tr₁-tr₇ and again at points tf₇-tf₁, to send an output 36 indicating the rising and falling edge of the signal as discussed above. By analyzing the output 36 of the comparators 26, the shape of the input signal 20 at a given time can be determined. Knowing the shape of the signal 20 allows for the extraction of data representing the intensity of light reflected off of different objects in the target area 14. Different levels in the signal will indicate different objects echoing their presence, while rising and falling edge segments indicate varying intensity of those objects. This is due to the fact that different objects in the target area 14 will reflect light at different intensities due to differing reflectivities and distances relative to each other. As discussed above, a processor could be programmed to receive the data and compile an image of the target area based on this information. For example, an image can be created and color coded where different peaks and rising and falling edge segments are identified by different colors. This leads the acquisition of more detailed information about the target area 14, which in turn permits a finer resolution image of the objects in the target area to be generated and identified by a user.

The speed of the system is dependent on the speed of the comparators 26, the time to store each vernier word in the registers 38, 40, the time to store data in the serializer 44, and the rate at which the data can be output 46 from the system. As best shown in FIG. 3, the serializer 44 may have an output 46 for each comparator 26. For example, the outputs 46 may be low voltage differential signal outputs. In an exemplary embodiment, each register 32 generates 12 bits of data for each latched event. Therefore, 24 bits of data can be streamed for each output 46.

It should be noted that the number of outputs 46 may vary depending on the requirements of the overall system. In an exemplary embodiment, the outputs 46 can have a data transfer rate as high as 1 giga sample per second (Gsps), so that it will take 24 nano seconds to stream out all seven outputs in parallel. Data may be streamed out while the next event is being captured by the comparators 26. Factoring in a slight delay for the comparators, data latching, and serial register, the total delay time may be approximately 26 nano seconds. In this example, the event rate will be approximately 38 MHz. This, however, may be increased if the number of outputs 46 is increased, such that each output 46 has to transfer less data. For example, if there is one output 46 per bit, the total delay time will be approximately 3 nanoseconds making the event rate for the system approximately 330 MHz.

The above-described method and apparatus provides a LIDAR system capable of determining both range information and the intensity information of light reflected from individual objects in a target area. This results in a higher resolution system, making LIDAR more effective for a range of applications including: topographical mapping, robot vision, factory automation, collision avoidance, smoke and camouflage visual penetration, and unmanned and manned navigation.

The foregoing description of the exemplary embodiments of the present invention has been presented for the purpose of illustration. It is not intended to be exhaustive or to limit the invention to the precise forms disclosed. Modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. For example, the methods and apparatus described can be utilized with and light imaging system, either scanning or flash type. Moreover, features or components of different embodiments may be substituted and combined with one another. Thus, the present invention is intended to cover all such modification and variations.

What is claimed:

1. A circuit for analyzing an input signal produced by a light detection and ranging device, comprising:
a plurality of comparators for receiving the input signal from the light detection and ranging device and for generating an output signal, said comparators each being associated with respective reference voltages that are unique for each of said comparators;
a plurality of register sets each electrically connected to and associated with a corresponding comparator of said plurality of comparators, each register set comprising at least two respective registers; and
at least one timing device for generating a timing signal, said timing device being electrically connected to said registers for transmitting said timing signal to said registers, said registers being operable to store data representing said timing signal and said output signal generated by said associated corresponding comparator.

2. The circuit of claim 1, wherein the comparators output a binary 0 when the value of said input signal is less than said associated reference voltage and the comparators output a binary 1 when said input signal is greater than said associated reference voltage.

3. The circuit of claim 2, wherein each comparator is connected to a first register which stores data when said associated comparator switches from a binary 0 to a binary 1, and a second register which stores data when said associated comparator switches from a binary 1 to a binary 0.

4. The circuit of claim 1, wherein said registers are vernier-type registers.

5. The circuit of claim 1, wherein the values of said reference voltages in the comparators differs by 1 least significant bit from one another.

6. The circuit of claim 1, wherein the data latched by said registers is output to a serializer.

7. The circuit of claim 6, wherein the serializer has at least one output for each comparator.

8. The circuit of claim 1, having 2^{N}−1 comparators where N is the desired resolution.

9. A light detection and ranging device comprising:
a light emitter for directing light towards a target area;
a light detector for receiving light reflected from a target area and generating a signal; and
an analyzer device connected to said light detector, wherein said analyzer device comprises the circuit of claim 1.

10. The light detection and ranging device of claim 9, further comprising a device for processing the data from said analyzer device to create an image of the target area, wherein the range of objects and the intensity of light received from individual objects in the target area are shown.

11. A method of imaging a target comprising the steps of:
emitting a flash of light to a target area;
activating a timing device when the light is initiated;
receiving light reflected from the target area;
converting the received light into a signal;
analyzing the signal to determine the time at which the signal crosses a plurality of thresholds.

12. The method of claim 11, wherein said analyzing step is performed by a circuit comprising a plurality of comparators and a timing device.

13. The method of claim 12, wherein the comparators and the timing device are connected to a plurality of registers.

14. The method of claim 11, further comprising the step of creating an image using the analyzed data.

15. The method of claim 14, wherein the range of objects and the intensity of light received from individual objects in the target area are shown.

16. A method of imaging a target comprising the steps of:
emitting a flash of light to a target area;
activating a timing device when the light is initiated;
receiving reflected light from the target area;
converting the received light into a signal;
analyzing the signal to determine the time of flight for the light and the intensity of the light as a function of time.

17. The method of claim 16, wherein said analyzing step is performed by a circuit comprising a plurality of comparators and a timing device.

18. The method of claim 17, wherein the comparators and the timing device are connected to a plurality of registers.

19. The method of claim 16, further comprising the step of creating an image using the analyzed data.

20. The method of claim 19, wherein the range of objects and the intensity of light received from individual objects in the target area are shown.
